(19) United States
(12) Patent Application Publication
(10) Pub. No.: US 2022/0046957 A1
(43) Pub. Date: Feb. 17, 2022

(54) METHOD OF TREATING A FEED MATERIAL

(71) Applicant: EW Nutrition GmbH, Visbek (DE)

(72) Inventors: Daniel Tepe, Oldenburg (DE); Cristian Atienza, Visbek (DE); Andreas Michels, Düsseldorf (DE)

(21) Appl. No.: 17/413,176

(22) PCT Filed: Dec. 12, 2019
(86) PCT No.: PCT/EP2019/084919

§ 371 Date: Jun. 11, 2021

(30) Foreign Application Priority Data
Dec. 12, 2018 (GB) 1820205.1

(51) Int. Cl. A23K 40/10; A23K 10/14; A23N 17/00; A23K 10/38

(52) U.S. Cl. CPC A23K 40/10; A23K 10/38; A23N 17/005; A23K 10/14

(57) ABSTRACT

The present invention relates to a method of treating a raw feed material, the method comprising a grinding step, an enzymatic treatment step, and a drying step, wherein the raw feed material is ground to obtain a meal in the grinding step, water is added and mixed into the meal to obtain a mixture, which is then subjected to an enzymatic treatment step with an enzyme preparation, to obtain an enzymatically treated mixture. The enzymatically treated mixture is dried in the drying step. The grinding process is adjusted in such way as to deliver a meal that has a particle size, measured as d50, between ≥100 μm and ≤1000 μm, whereas water is added to achieve a total water content of between ≥15% w/w and ≤40% w/w.

### FIELD OF THE INVENTION

The present invention relates to the field of feed material for animal consumption.

### BACKGROUND

Animal feed refers particularly to foods given to the animals rather than that which they forage for themselves. Feed includes hay, straw, silage, compressed and pelleted feeds, oils and mixed rations, and sprouted grains and legumes.

Feed grains are a substantial source of animal feed globally. The two most important feed grains are maize and soybean. Other feed grains include wheat, oats, barley, sorghum and rice, among many others. Traditional sources of animal feed include household food scraps and the byproducts of food processing industries such as milling and brewing. Material remaining from milling oil crops like peanuts, soy, and corn are important sources of fodder. Scraps fed to pigs are called slop, and those fed to chicken are called chicken scratch. Brewer's spent grain is a byproduct of beer making that is widely used as animal feed.

Compound feed is fodder that is blended from various raw materials and additives. These blends are formulated according to the specific requirements of the target animal. They are manufactured by feed compounders as meal type, pellets or crumbles.

Different types of feed vary substantially in their nutritional content and their digestability. Further, feed material may comprise antinutritional factors, i.e., ingredients that negatively affect the digestability of the feed (e.g., by inhibiting enzymes of the digestive tract), or limit the amount of feed that an animal can consume (e.g., because they are immunogenic or even toxic).

In order to increase the nutritional content and/or the digestability of a given feed, enzymes have recently been introduced which are added to the feed prior to consumption.

Generally, these enzymes include carbohydrases (like xylanase, beta-glucanase and amylase, to degrade long chain carbohydrases and thus increase the amount of glucose an animal can obtain from a given portion of feed), phytases (to degrade phytate and release phosphorous for increase uptake) and proteases (to increase protein uptake and degrade proteins that bind starch within feed ingredients or degrade antinutritive proteins like protease inhibitors).

However, though many anti nutritional factors could be addressed, and degraded, with suitable enzymes, hence yielding the possibility to increase the nutritional value and/or the digestability of a given feed, the industry has so far not developed suitable enzymatic approaches.

Further, there are no individualized approaches available today which allow batch-specific adaptation of the enzyme treatment, to account for individual characteristics of a given feed batch (i.e., specific antinutritional factors, individual nutritional profile, etc.).

It is hence one object of the present invention to provide an approach to allow batch specific treatment of feed. It is another object of the present invention to allow the use of enzymes which so far have not been used in animal feed processing. It is another object of the present invention to provide a more cost effective approach to improve the nutritional value of animal feed. It is another object of the present invention to provide a cost effective approach to reduce the impact of anti-nutritional factors in animal feed.

### SUMMARY OF THE INVENTION

These and further objects are met with methods and means according to the independent claims of the present invention. The dependent claims are related to specific embodiments.

### EMBODIMENTS OF THE INVENTION

Before the invention is described in detail, it is to be understood that this invention is not limited to the particular component parts of the devices described or process steps of the methods described as such devices and methods may vary. It is also to be understood that the terminology used herein is for purposes of describing particular embodiments only, and is not intended to be limiting. The mere fact that certain measures are recited in mutually different dependent claims does not indicate that a combination of these measures cannot be used to advantage. Any reference signs in the claims should not be construed as limiting the scope. It must be noted that, as used in the specification and the appended claims, the singular forms “a,” “an” and “the” include singular and/or plural referents unless the context clearly dictates otherwise. It is moreover to be understood that, in case parameter ranges are given which are delimited by numeric values, the ranges are deemed to include these limitation values.

According to one aspect of the invention, a method of treating a raw feed material, the method comprising a grinding step, an enzymatic treatment step, and a drying step, is provided, wherein
a) the raw feed material is ground to a obtain a meal in the grinding step,
b) water is added and mixed into the meal to obtain a mixture, which is then subjected to an enzymatic treatment step with an enzyme preparation, to obtain an enzymatically treated mixture, and
c) the enzymatically treated mixture is dried in the drying step, and
   wherein further
in step a), the grinding process is adjusted in such way as to deliver a meal that has a particle size, measured as d50, between ≥100 μm and ≤1000 μm
in step b), water is added to achieve a total water content of between ≥15% w/w and ≤40% w/w

Generally, in a process that involves subjecting a substrate to an enzymatic treatment step, a skilled person would strive to establish a highly aqueous environment, in order to optimize the reaction conditions the enzyme preparation is exposed to.

At the same time, a skilled person would strive to grind the raw feed material as fine as possible, in order to create a maximally large relative surface of the substrate, which again contributes to an optimization of the reaction conditions the enzyme preparation is exposed to.

However, the inventors of the present invention have realized that the feed industry is under substantial cost pressure, which requires careful process design, in particular with regard to energy consumption and process time.

Drying a mixture comprising meal and water is highly energy intensive, and energy demand increases with water content. Likewise, drying time increases with water content.

Grinding a raw feed material is also highly energy intensive and energy demand increases with grinding grade (the finer, the higher the energy demand). Likewise, grinding time increases with grinding grade.

Hence, the inventors have realized that, while it is desirable to obtain maximal enzymatic substrate conversion, restraints with regard to energy consumption and process time have also to be considered.

In order to solve this target conflict, the inventors have developed a process where two input parameters (grinding grade/particle size and water content) are, counter-intuitively, maintained in given corridors, so as to establish an optimum relationship between enzymatic substrate conversion and energy consumption/process time.

d50 (also written as “D50”), as used herein, is a measure for particle size distribution. D50 is also known as the median diameter or the medium value of the particle size distribution, hence is the value of the particle diameter at 50% in the cumulative distribution. If d50=580 mm, then 50% of the particles in the sample are larger than 580 μm, and 50% are smaller than 580 μm.

Particle size in general, and d50 in particular, can be measured with a large array of measurement techniques.

The preferred technique is Sieve analysis, which is often used because of its simplicity, cheapness, and ease of interpretation. Methods may be simple shaking of the sample in sieves until the amount retained becomes more or less constant. Alternatively, the sample may be washed through with a non-reacting liquid (usually water) or blown through with an air current. This technique is well-adapted for bulk materials. Two common uses in the powder industry are wet-sieving of milled limestone and dry-sieving of milled coal.

Sieve analysers that can be used in the context of the present invention are for example manufactured by Retsch GmbH, Haan (Germany) or Fritsch GmbH, Idar-Oberstein (Germany)

The standard for particle size analysis by sieving is published by the American Society of Agricultural and Biological Engineers (ASABE). As stated in their publication, Method of Determining and Expressing Fineness of Feed Materials by Sieving (ANSI/ASAE S319.4 Feb. 2008 R2012), the purpose of this standard is to define a test procedure to determine the fineness of feed ingredients and to define a method of expressing the particle size of the material.

Test Procedures A stack of sieves (each sieve possessing a different diameter opening) separates feed particles according to size. They are identified by diameter opening in millimeters or microns. It is recommended that the U.S. Standard, 8-inch diameter, half height sieve with a brass frame and mesh be used (ANSI/ASAE S319.4 Feb. 2008 R2012).

In the feed industry, computer software provides the easiest method for calculating particle size. Pfost (1976), the content of which is incorporated herein by reference for enablement purposes, described equations that can be used to calculate dgw, Sgw, surface area, and particles per gram based upon a log-normal distribution of ground grain samples. For the purpose of this study Geometric standard deviation Sgw was used. The sgw measurement of the particle size variation around the Geometric diameter average. (dgw: Geometric diameter average is the average particle size, in microns, of a sample)

The steps in particle size analysis are for example as follows:
1. Obtain a representative sample of 100±5 grams by following the procedures for collecting and splitting a representative sample as described in the K-State Research and Extension publication MF-2036 Sampling: Procedures for Feed.
2. Ensure that each sieve is cleaned and agitators are in the proper arrangement with the sieve opening decreasing from top to bottom
3. Weigh each sieve individually with the agitators to obtain a tare weight.
4. Weigh 0.5 grams of flow agent and mix with 100±grams sample. Read safety data sheet for the flow agent before product use.
5. Place the mixture of sample and flow agent on the top sieve and place sieve stack on the shaker machine. Allow shaker machine to run for 10 minutes.
6. Remove the sieve stack from shaker machine.
7. Weigh each sieve and retained material together to obtain the weight of sample on each sieve.

Another technique is air elutriation analysis, which employs an apparatus with a vertical tube through which fluid is passed at a controlled velocity. When the particles are introduced, often through a side tube, the smaller particles are

Another technique is Photoanalysis/optical granulometry. Unlike sieve analyses which can be time-consuming and inaccurate, taking a photo of a sample of the materials to be measured and using software to analyze the photo can result in rapid, accurate measurements. Another advantage is that the material can be analyzed without being handled. This is beneficial in the agricultural industry, as handling of food products can lead to contamination. Photoanalysis equipment and software is currently being used in mining, forestry and agricultural industries worldwide.

Other techniques ware well established in the art and available to the skilled person

In a preferred embodiment, in step a), the grinding process is adjusted in such way as to deliver a meal that has a particle size, measured as d50 of ≥125 μm; ≥150 μm; ≥175 μm; ≥200 μm; ≥225 μm; ≥250 μm; ≥275 μm; ≥300 μm; ≥325 μm; ≥350 μm; ≥375 μm; ≥400 μm; ≥425 μm; ≥450 μm; ≥475 μm; or ≥500 μm.

In a preferred embodiment, in step a), the grinding process is adjusted in such way as to deliver a meal that has a particle size, measured as d50 of ≤975 μm; ≤950 μm; ≤925 μm; ≤900 μm; ≤875 μm; ≤850 μm; ≤825 μm; ≤800 μm; ≤775 μm; ≤750 μm; ≤725 μm; ≤700 μm; ≤675 μm; ≤650 μm; ≤625 μm; ≤600 μm; ≤575 μm; ≤550 μm; ≤525 μm or ≤500 μm.

With regard to the above mentioned lower and upper limitations, all possible combination shall be deemed disclosed herewith.

In preferred embodiments, the grinding process is adjusted in such way as to deliver a meal that has particle size, measured as d50, between ≥100 μm and ≤1000 μm; between ≥125 μm and ≤975 μm; between ≥150 μm and ≤950 μm; between ≥175 μm and ≤925 μm; between ≥200 μm and ≤900 μm; between ≥225 μm and ≤875 μm; between ≥250 μm and ≤850 μm; between ≥275 μm and ≤825 μm; between ≥300 μm and ≤800 μm; between ≥325 μm and ≤775 μm; between ≥350 μm and ≤750 μm; between ≥375 μm and ≤725 μm; between ≥400 μm and ≤700 μm; between ≥425 μm and ≤675 μm; between ≥450 μm and ≤650 μm; between ≥475 μm and ≤625 or between ≥500 μm and ≤600.

In further preferred embodiments, the grinding process is adjusted in such way as to deliver a meal that has particle size, measured as d50, between ≥100 μm and ≤1000 μm; between ≥125 μm and ≤950 μm; between ≥150 μm and ≤900 μm; between ≥175 μm and ≤850 μm; between ≥200 μm and ≤800 μm; between ≥225 μm and ≤750 μm; between ≥250 μm and ≤700 μm; between ≥275 μm and ≤650 μm; between ≥300 μm and ≤600 μm; between ≥325 μm and ≤550 or between ≥350 μm and ≤500 μm.

In further preferred embodiments, the grinding process is adjusted in such way as to deliver a meal that has particle size, measured as d50, between ≥105 μm ≤730 μm; between ≥130 μm ≤680 μm; between ≥155 μm ≤630 μm; between ≥180 μm ≤580 μm; between ≥205 μm ≤530 μm; between ≥230 μm ≤480 μm; between ≥255 μm ≤430 μm or between ≥280 μm ≤380 μm.

In a preferred embodiment, in step b), water is added to achieve a total water content of ≥16% w/w; ≥17% w/w; ≥18% w/w; ≥19% w/w; ≥20% w/w; ≥21% w/w; ≥22% w/w; ≥23% w/w; ≥24% w/w; ≥25% w/w; ≥26% w/w; ≥27% w/w; ≥28% w/w; ≥29% w/w; ≥30% w/w; ≥31% w/w; ≥32% w/w; ≥33% w/w; ≥34% w/w; ≥35% w/w; ≥36% w/w; ≥37% w/w; ≥38% w/w or ≥39% w/w.

In a preferred embodiment, in step b), water is added to achieve a total water content of ≤39% w/w; ≤38% w/w; ≤37% w/w; ≤36% w/w; ≤35% w/w; ≤34% w/w; ≤33% w/w; ≤32% w/w; ≤31% w/w; ≤30% w/w; ≤29% w/w; ≤28% w/w; ≤27% w/w; ≤26% w/w; ≤25% w/w; ≤24% w/w; ≤23% w/w; ≤22% w/w; ≤21% w/w; ≤20% w/w; ≤19% w/w; ≤18% w/w; ≤17% w/w or ≤16% w/w.

In another preferred embodiment, in step b), water is added to achieve a total water content of between ≥16% w/w and ≤39% w/w; between ≥17% w/w and ≤38% w/w; between ≥18% w/w and ≤37% w/w; between ≥19% w/w and ≤36% w/w; between ≥20% w/w and ≤35% w/w; between ≥21% w/w and ≤34% w/w; between ≥22% w/w and ≤33% w/w; between ≥23% w/w and ≤32% w/w; between ≥24% w/w and ≤31% w/w or between ≥25% w/w and ≤30% w/w. In another preferred embodiment, in step b), water is added to achieve a total water content of between ≥16% w/w and ≤34% w/w; between ≥17% w/w and ≤33% w/w; between ≥18% w/w and ≤32% w/w; between ≥19% w/w and ≤31% w/w; between ≥20% w/w and ≤30% w/w; between ≥21% w/w and ≤29% w/w; between ≥22% w/w and ≤28% w/w; between ≥23% w/w and ≤27% w/w or between ≥24% w/w and ≤26% w/w.

Maintaining the particle size and the water content in the above identified corridors ensures that an optimized ratio between total energy consumption (which is a function of the energy needed for grinding and the energy needed for drying) and resulting water activity or enzymatic substrate conversion is established.

The approach to maintain the particle size and the water content in the above identified corridors is new and has so far not been reported. Then inventors have surprisingly shown that these two input parameters allow to optimize the production process, by keeping the enzymatic substrate conversion as high as possible, and at the same time reducing the energy consumption of the entire process to as low as possible.

As used herein, the term “raw feed material” relates to material that is being used for preparing animal feed.

The claimed process substantially reverses the current approach of using enzymes in animal feed, where the enzymes are added to the respective feed on site, i.e., in the feed mill or on the farm, without any subsequent treatment. The rationale of this approach is to not degrade or inactivate the enzymes so as to obtain the highest possible conversion rate. The enzymes that are currently used hence complement the enzyme activity of the animal's digestive tract, where carbohydrases, phytases and proteases are active anyway. For that reason, the current rationale has no concerns that the added enzymes remain active even in the animal's digestive tract. For this reason also, enzymes currently used in feed applications need to undergo regulatory approval (see below).

As discussed, the claimed process substantially reverses such approach, and hence acts counter current thinking. There are substantial issues that the claimed process takes into account, because, once the drying takes place, the enzymes are inactivated either due to denaturation or because the water content is reduced.

Hence, the claimed process provides only a limited amount of time for the enzymes to be active, taking into account a potentially lower conversion rate.

On the other hand, the claimed ex vivo approach offers more control on enzymatic conversion of the feed material than the current in vivo approach, where the enzymes are mixed into the feedstuff prior to feeding, hence exposing the enzymatic conversion to poorly controlled conditions subject to individual-specific variations.

In other approaches where crops are treated with enzymes, a wet milling process is established wherein the kernels are soaked or steeped, e.g., to begin breaking the starch and protein bonds. The next step in the process involves a coarse grind to break the pericarp and separate the germ from the rest of the kernel. The remaining slurry consisting of fiber, starch and protein is finely ground and screened to separate the fiber from the starch and protein. Then, the resulting meal is treated with enzymes, e.g., proteases, to improve the release of starch from the meal.

In such methods, as e.g. disclosed in EP3074426A1 assigned to Novozymes, the addition of proteases significantly reduces the total processing, and hence eliminates the need for sulfur dioxide as a processing agent, which would otherwise be necessary to stop bacterial growth. Quite obviously, such addition of sulfur dioxide is not appropriate in an animal feed application, as the entire process is rather suitable to produce starch, and not an application to produce animal feed.

Other applications encompass the production of ethanol (U.S. Pat. No. 8,962,286 assigned to Direvo), wherein however only the fermented mash is subjected to an enzyme treatment (not the wetted meal).

According to one embodiment, in step b) water is added to the meal to obtain a resulting water activity of ≥0.8.

The term “water activity” or α_{w}, determines the partial vapor pressure of water in a substance divided by the standard state partial vapor pressure of water. In the field of food science, the standard state is most often defined as the partial vapor pressure of pure water at the same temperature. Using this particular definition, pure distilled water has a water activity of exactly 1.

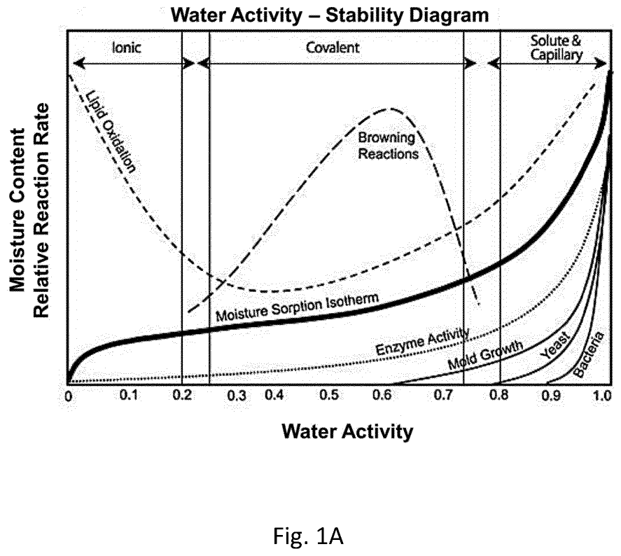

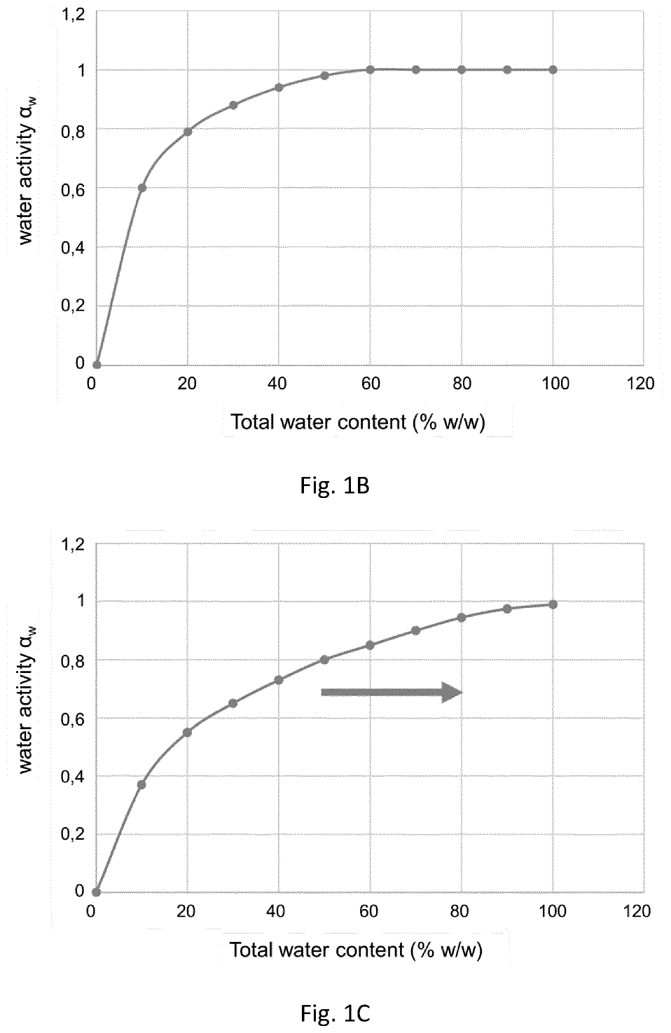

It is important to understand that a high water activity in a material comprising an enzyme substrate and an enzyme is beneficial to obtain a high enzyme activity, hence resulting in high enzymatic conversion rates. See FIG. 1A of a respective illustration. This means, from this point of view, one would have an incentive to increase the water activity to a value as high as possible to obtain a maximum possible substrate conversion.

However, in the present context, energy consumption considerations play an important role, because drying an aqueous slurry comprising a feed meal is an energy intensive process. From this point of view, one would have the incentive to add only small amounts of water to the feed meal, to keep the total water content low, and hence reduce subsequent drying costs.

Hence, there exists a target conflict when establishing a treatment process as set forth above.

Now there is a saturated relationship between water activity aW and total water content when a water absorbing meal is soaked, as shown in FIG. 1B. Once the water absorbing meal is saturated, the water activity remains stable, because further added water is no longer soaked up by the meal.

In one embodiment, the ratio between the total water content and water activity depends on the milling grade of the grinding process. The finer the resulting meal is, the more water it absorbs, hence the water activity saturation curve is shifted to the right. See FIG. 1C for an explanation. In this embodiment, the grinding step serves to adjust the ratio between water activity and total water content once water has been added to the meal.

According to one embodiment, the method further comprises at least one step selected from the group consisting of:
at least one analysis step for determining key parameters of the raw feed material or an intermediate material, and/or
a hydrothermal treatment step to degrade fibres comprised in the raw feed material or an intermediate material.

As used herein, the term “hydrothermal treatment” relates to a process in which the fibres in the feed material (e.g., from grain hulls or bean hulls) are degraded. As a result, the fermentation capability in the animal's large intestine is improved, supporting a balanced gut microflora. Further, the digestability of the feed material increases, while the thus treated fibre also enable a higher water holding and swelling capacity. This leads also to a positive influence on the gut motility. Methods and protocols of such treatment are e.g. shown in Hedegaard et al, Bioresource Technology Volume 99 (10), July 2008, Pages 4221-4228, the content of which is incorporated herein by reference.

According to one embodiment, the drying step serves to reduce the total water content of the feed material thus treated to ≤11 w/w.

In preferred embodiments, the drying step serves to reduce the total water content to ≤10, 9, 8, 7 or ≤6% w/w.

According to one embodiment the grinding step results in an average particle size of the resulting meal of between ≥100 μm and ≤2000 μm, meaning the maximum number of particles in a Gaussian size distribution.

According to another embodiment, the grinding step is performed with a hammer mill or a ball mill.

A hammer mill is essentially a steel drum containing a vertical or horizontal rotating shaft or drum on which hammers are mounted. The hammers are free to swing on the ends of the cross, or fixed to the central rotor. The rotor is spun at a high speed inside the drum while material is fed into a feed hopper. The material is impacted by the hammers and is thereby reduced and expelled through screens in the drum of a selected particle size.

A ball mill consists of a hollow cylindrical shell rotating about its axis. The axis of the shell may be either horizontal or at a small angle to the horizontal. It is partially filled with balls. The grinding media is the balls, which may be made of steel (chrome steel), stainless steel, or ceramic. The inner surface of the cylindrical shell is usually lined with an abrasion-resistant material such as manganese steel or rubber.

According to another embodiment, the enzymatic treatment step is performed in one or more batch reactors. According to another embodiment, multiple batch reactors are operated in a time-displaced manner.

Preferably, the batch reactors are so-called enzymatic hoppers. In one embodiment, 3 such batch reactors are being used (one empty, one in the process of being filled, one is in the process of harbouring the enzymatic conversion).

According to another embodiment, the enzymatic treatment step has at least one of the following parameters:
Retention time: Between ≥10 and ≤45 min
Temperature: Between ≥25 and ≤50° C., preferably between ≥30 and ≤50° C., more preferably between ≥35 and ≤45° C., most preferably between ≥38 and ≤42° C.
pH: Between ≥3 and ≤8, preferably between ≥4 and ≤7, more preferably between ≥5 and ≤6, most preferably between ≥5.3 and ≤5.7
pressure atmospheric pressure

According to another embodiment, the drying step has the following parameters:
Temperature: Between ≥70 and ≤130° C., preferably between ≥80 and ≤120° C., more preferably between ≥90 and ≤110° C., most preferably between ≥95 and ≤105° C.
pressure atmospheric pressure

The drying step can be carried out on a fluid bed dryer. In such dryer, air heated at a given temperature is blown under pressure into a lower chamber and forced to pass through small openings in the ceiling into an upper chamber. Ingredients are suspended in moving streams of hot air and assume the kinetics of a fluid. As there is no contact between materials and the direct source of heat and the air speed avoids developments of air/dust mixtures, there are minimal risk of explosion. According to another embodiment, the drying step is preferably carried out on a rotary drum dryer. Such dryer is usually made up of a large, rotating cylindrical tube, usually supported by concrete columns or steel beams. The dryer is inclined to slopes slightly so that the discharge end is lower than the material feed end in order to convey the material through the dryer under gravity. Material to be dried enters the dryer, and as the dryer rotates, the material is lifted up by a series of internal fins lining the inner wall of the dryer.

The drying step can likewise be performed in a rotary dryer, or, as mentioned elsewhere herein, in a convective dryer.

According to one embodiment, the drying step serves to denaturate the enzymes added to the feed material. Such denaturation occurs upon prolonged exposure to temperatures higher than 55° C. Hence, conditions as set forth above for drying are usually more than sufficient to denaturate the enzymes added to the feed material.

According to one embodiment, the analysis step serves to determine at least one parameter selected from the group consisting of:
Digestible protein content
Water activity,
Total water content/moisture content
Fibre content
Content of antinutritional factors

As regards water activity, there are three basic water activity measurement systems. These are Resistive Electrolytic Hygrometers (REH), Capacitance Hygrometers and Dew Point Hygrometers (sometimes called chilled mirror).

The typical system uses a sealed temperature controlled chamber. A sample is placed in the chamber and sealed. The free water is allowed to escape into the air in the chamber. It remains there until all the free water has left the sample.

At equilibrium the relative humidity of the air in the chamber is measured. The relation of this reading to pure water is the water activity measurement expressed as the term aw. The range of water activity is from zero (no free water) to 1.0 (pure water)

Total moisture content (MC) is the weight of water contained in grains expressed in percent. Moisture content of grain can be measured by using either weight measurements like the oven method or an infrared moisture balance, or an electronic instrument that uses electrical characteristics of the grains.

Digestible protein content can be determined with an enzymatic in vitro digestibility technique, as e.g. disclosed in Ramos et al. (1992), who developed an enzymatic in vitro method to estimate the nutritive value of feeds based on the method proposed by Boisen (1991) for pigs. The content of these documents is incorporated herein by reference.

Fiber content in a sample is measured in the laboratory by what is called an enzymatic-gravimetric method. After defatting, a food sample is treated with enzymes that mimic the digestive process in the human small intestine. Digestible carbohydrates are broken down into simple sugars and removed from the sample by precipitation and filtration. This mimics absorption of these sugars in the body. The non-digestible precipitate contains the dietary fiber but also contains protein and inorganic material. These should not be included in dietary fiber so protein and inorganic material must be measured separately and subtracted from the weight In another embodiment, part or all of the above measurements are carried out in a NIR spectrometer. This applies, inter alia, to the determination of crude protein, dry matter, essential, and non-essential amino acids and antinutritional factors.

According to another embodiment, the one or more enzymes added to the feed material are selected from the group consisting of:
protease
phytase
carbohydrase (e.g., cellulase, hemicellulose, alpha-galactosidase), and/or
toxin degrading enzymes

These enzymes increase the nutritional values of the raw feed material, by releasing and/or degrading proteins, phytate/phosphorous and/or starch or sugars, or by degrading toxins, like e.g. mycotoxins which have developed on the field (e.g., ergot toxin) or during storage (e.g., mold toxin)

According to another embodiment, the one or more enzymes added to the feed material are capable of degrading, digesting or hydrolyzing one or more antinutritional factors (ANF). Antinutritional factors are substances that when present in animal feed or water reduce the availability of one or more nutrients. Some antinutritional factors are shown in the following list:
phytate/phytic acid
protease inhibitors
lipase inhibitors
amylase inhibitors
oxalic acid
glucosinolates
lectins
saponins

Protease inhibitors are substances that inhibit the actions of trypsin, pepsin and other proteases in the gut, preventing the digestion and subsequent absorption of protein. For example, Bowman-Birk trypsin inhibitor and Kunitz STI protease inhibitor are found in soybeans.

Lipase inhibitors interfere with enzymes, such as human pancreatic lipase, that catalyze the hydrolysis of some lipids, including fats. For example, the anti-obesity drug orlistat causes a percentage of fat to pass through the digestive tract undigested.

Amylase inhibitors prevent the action of enzymes that break the glycosidic bonds of starches and other complex carbohydrates, preventing the release of simple sugars and absorption by the body. Amylase inhibitors, like lipase inhibitors, have been used as a diet aid and obesity treatment. Amylase inhibitors are present in many types of beans; commercially available amylase inhibitors are extracted from white kidney beans.

Phytic acid has a strong binding affinity to minerals such as calcium, magnesium, iron, copper, and zinc. This results in precipitation, making the minerals unavailable for absorption in the intestines. Phytic acids are common in the hulls of nuts, seeds and grains.

Oxalic acid and oxalates are present in many plants, particularly in members of the spinach family. Oxalates bind to calcium and prevent its absorption in the human body.

Glucosinolates prevent the uptake of iodine, affecting the function of the thyroid and thus are considered goitrogens. They are found in broccoli, brussel sprouts, cabbage and cauliflower.

Saponins found in some plants may serve as anti-feedants, similar to lectins found in may legumes.

By degrading, digesting or hydrolyzing the amount of anti-nutritional factors (ANF) in the feed material, the relative value of a given feedstuff can be increased. Harmful components like ANF can be turned into high value raw peptide or raw protein contents

Example substrates and the respective enzymes that can be added in the context of the present invention are shown in the following, non limiting list:

| | |
|---|---|
| substrate | enzyme |
| disaccharides | disaccharidase |
| oligosaccharides | alfa galactosidase |
| starch | amylase |
| cellulose | cellulase |
| hemicellulose | hemicellulase |
| pentosans (arabinoxylans) | xylanase |
| beta glucans | beta glucanase |
| mannans | mannanse |
| pectic substances | pectinase, poly-galacturonase |
| phytate/phytic acid | phytases |
| protease inhibitors (e.g., kunitz trypsin | protease |
| inhibitor (kti) and bowman-birk | |
| inhibitor (bbi)) | |
| lipase inhibitors | protease |
| amylase inhibitors | protease |
| oxalic acid | oxalate decarboxylase |
| | oxalate oxidase |
| | oxalyl-CoA decarboxylase |
| glucosinolates | myrosinase (thioglucoside |
| | glucohydrolase) |
| lectins | protease |
| zearalenone (mycotoxin) | zeralenonase |
| saponins | saponin hydrolase |

According to one embodiment of the invention, one or more enzymes, and their dosage are selected according to the outcome of the analysis step. In this embodiment, a lot-specific enzyme cocktail can be prepared in real time according to the outcome of the analysis step.

| | Result of analysis: | |
|---|---|---|
| Crop | High in . . . | Suitable enzyme cocktail |
| Corn | . . . Arabinoxylan, Cellulose | Xylanase, Cellulase, |
| | | Amylase |
| Soya bean | . . . Cellulose, ANF | Cellulase, Phytase, |
| meal | | Protease |
| Sun flower | . . . Cellulose, Arabinoxylan | Cellulase, Xylanase, |
| meal | | Phytase |

Amylase breaks down the starch molecules in plant material, which provides energy to the animal (Corn contains about 70% starch). Protease acts by reducing the lectin level and potential KTI and BBI levels, thereby reducing the sensitivity of the animal performance to low quality soya bean meal).

One particular advantage is that the invention reduces the regulatory burden regarding the enzymes being used in the feed raw material.

Enzymes are proteins and can as such have a detrimental effect on animals consuming them. Such effect can either be caused by immunogenicity, toxicity or unwanted enzymatic effects in the animal. In Europe, enzymes which are used in animal nutrition (feed enzymes) are considered as feed additives. Production and marketing of feed additives—and thus feed enzymes—are regulated by the following legal provisions:
Regulation 1831/2003 on feed additives.
Guidelines for feed additives (Regulation 429/2008).
Regulation 183/2005 on feed hygiene, supplemented by codes of practice such as FAMI-QS.
Regulation 767/2009 on the marketing of feed.

An explicit EU authorization needs to be obtained before placing a feed enzyme on the market. For this, a comprehensive dossier—demonstrating that the product is safe for the users, target animals, consumers and the environment and efficient—needs to be submitted to the EFSA (European Food Safety Agency) and the European Commission for approval. The EFSA reviews the dossier and publishes a scientific opinion. The final authorization is issued by means of a Commission Regulation after consulted formal vote of the Member States). This authorization is valid ten years. In the United States and other industrialized markets, similar provisions apply.

The entire authorization process is a time consuming and costly procedure, which significantly increases the market price for enzymes used in feed applications.

The inventors have realized that, in case the feed material that has been enzymatically treated undergoes a thermal treatment at suitable conditions, the enzymes comprised therein are irreversibly denatured, hence losing not only their enzymatic activity, but also potential toxicity and/or immunogenicity. In such way, the enzymes are merely reduced to simple raw peptides that still form part of the protein content of the feed, yet without having any enzymatic or harmful properties left.

In such way, the regulatory burden involved with the use of enzymes for treating feed raw material is significantly reduced.

According to another embodiment, the raw feed material is at least one selected from the group consisting of:
soy bean meal,
corn,
rapeseed,
sun flower meal,
barley,
wheat, and/or
DDGS (dried distillers grains with solubles).

According to another embodiment, for mixing water into the meal a mixer is used which combines a shaft paddle mixer and a lump breaker.

Such mixer allows to obtain better homogeneity results in meal-water mixtures having a water contents of >10% w/w, than a conventional shaft paddle mixer. Such shaft paddle mixer is typically used to mix different types of raw feed material, or meal thereof, because, in the feed industry, raw feed materials are typically mixed as dry matter. Adding water to such mixture is counter intuitive and will usually not be done.

Because with increasing water content, viscosity will increase (at least until a very high water content of >90% w/W is reached). Further aggregates will form, all of which blocks the entire mixing process.

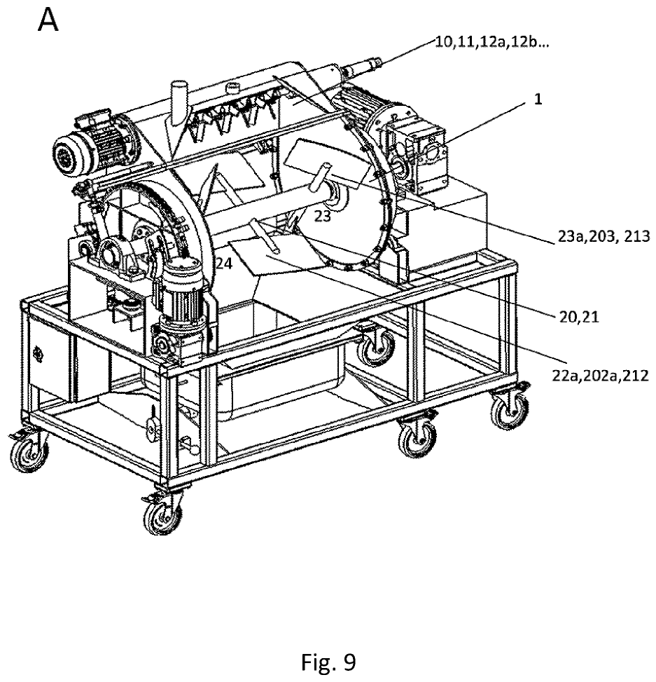

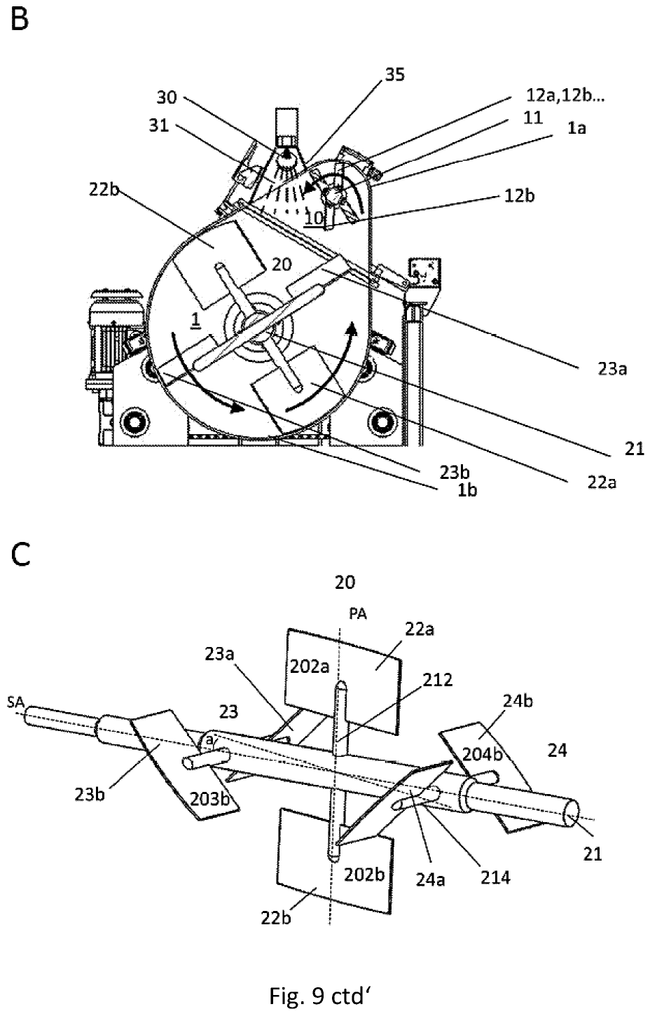

The mixer that is preferably used in the method according to the invention is capable of mixing such mixtures with a water content of >10% w>/W, irrespective of increasing viscosity and lump formation. Preferably, its lump breaker comprises one or more tulip knifes or high speed choppers. One such mixer is published in EP publication EP3573744. The mixer disclosed therein is shown in FIG. 9 of the present application.

According to another aspect of the invention, a feed material treated with a process according to the above description is provided. According to another aspect of the invention, a feedstuff comprising a feed material according to the above description is provided.

According to one embodiment, the feedstuff is provided as pellets, powder and/or meal.

According to another aspect of the invention, a system for carrying out the method according to the above description is provided, said system comprising
a mill to grind a raw feed material to obtain a meal,
a water supply to add water to the meal,
a mixer for mixing water into the meal,
an enzyme supply to add an enzyme preparation to the watered meal,
a fermenter for the enzymatic treatment of the thus treated watered meal,
and a dryer to dry the enzymatically treated meal.

The different elements, including the mill and the mixer are preferably the ones that are disclosed herein as preferred embodiments.

According to one embodiment, the system further comprises at least one device selected from the group consisting of:
an analysis unit for determining key parameters of the feed material, and/or
a hydrothermal treatment unit capable to degrade fibres comprised in the feed material or the meal obtained therefrom.

According to another aspect of the invention, a feedmill comprising a system according to the above description is provided.

### EXPERIMENTS AND FIGURES

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

### SHORT DESCRIPTION OF THE FIGURES

FIG. 1 shows the relationship between water activity and enzyme activity. Generally, the higher the water activity, the better the enzyme activity is.

This means, from this point of view, one would have an incentive to increase the water activity to a value as high as possible to obtain a maximum possible substrate conversion. However, in the present context, energy consumption considerations play an important role, because drying an aqueous slurry comprising a feed meal is an energy intensive process. From this point of view, one would have the incentive to add only small amounts of water to the feed meal, to keep the total water content low, and hence reduce subsequent drying costs.

FIG. 1B shows the relationship between water activity and total water content of a slurry comprising a meal of a water absorbing feed material. It can be seen that said relationship relies on a saturation curve. Once the water absorbing meal is saturated, the water activity remains stable, because further added water is no longer soaked up by the meal.

FIG. 1C shows such saturation curve in an experiment with a more finely ground meal. The inventors have now shown that the ratio between the total water content and water activity depends on the milling grade of the grinding process. The finer the resulting meal is, the more water it absorbs, hence the water activity saturation curve is shifted to the right, as indicated by the arrow in FIG. 1C.

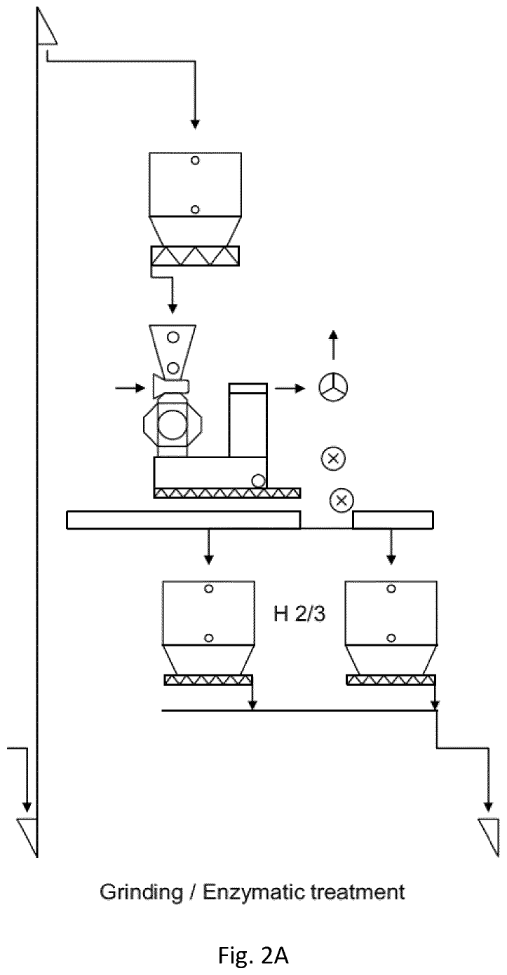

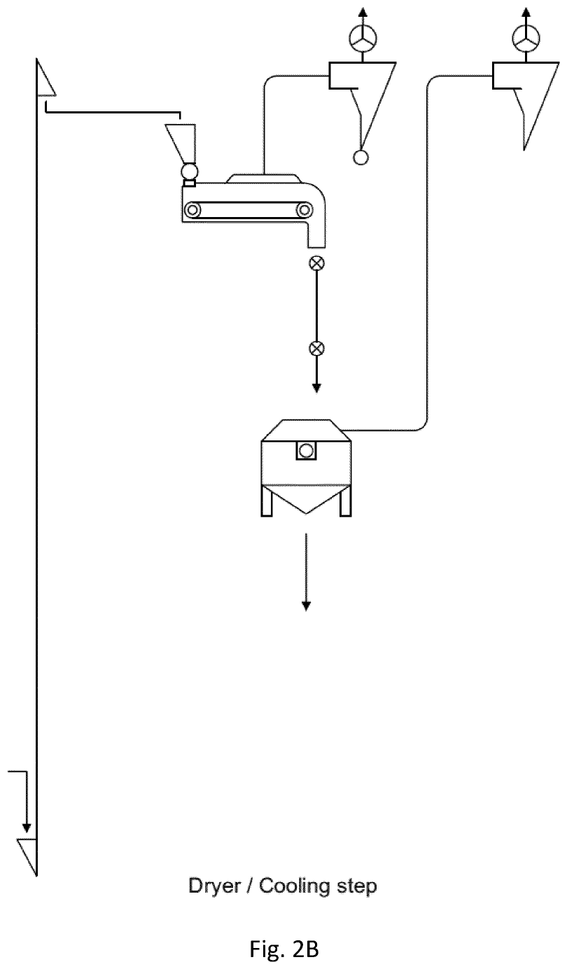

FIG. 2A shows a schematic illustration of the first two steps of the process, i.e., the grinding step and the enzymatic treatment step. FIG. 2B shows a schematic illustration of the follow-on step of the process, i.e., the drying step.

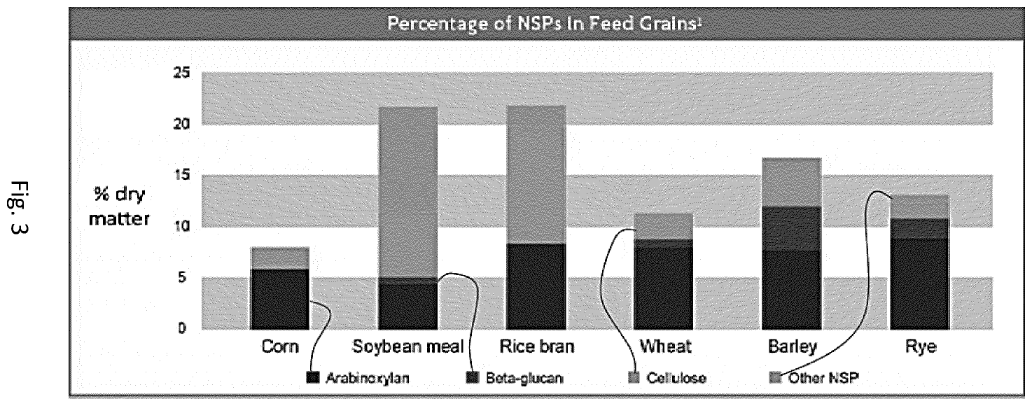

FIG. 3 shows the composition % DM and non-starch polysaccharides (NSP) species in different crops, as shown in the following tables:

TABLE 1
Composition of maize, wheat and soybean meal (% DM)
(from Graham and Aman 2014)

| Analytical component | | | Soybean |
|---|---|---|---|
| (% DM) | Maize | Wheat | meal |
| Ash | 1.4 | 1.7 | 6.6 |
| Crude protein | 9.1 | 11.0 | 53.3 |
| Crude fat | 4.6 | 2.4 | 2.8 |
| Sugars | 2.6 | 3.5 | 3.5 |
| Oligosaecharides | 0.3 | 0.2 | 5.3 |
| ructans | 0..6 | 1.8 | 0.9 |
| Starch | 69.0 | 66.5 | 0 |
| Crude fibre | 2.3 | | |
| Acid deterent fibre | 2.5 | 3.4 | 4.9 |
| Neutral detergent fibre | 9.2 | 10.0 | 8.4 |
| Non-starch polysaccharides + | 10.0 + 0.8 | 11.0 + 1.0 | 20.8 + 1.0 |
| lignin | | | |
| Non-starch polysaccharides | | | |
| rhamnose | Tr | Tr | 0.7 |
| arabinose | 2.3 | 2.7 | 2.3 |
| xylose | 3.1 | 3.9 | 1.5 |
| mannose | Tr | Tr | 1.4 |
| galactose | 0.5 | 0.2 | 5.3 |
| glucose | 3.4 | 3.7 | 6.0 |
| uronie acids | 0.7 | 0.5 | 3.8 |

TABLE 2
The types and levels on non-starch polysaccharides present in some
cereals grains and their by-products (% DM) (from Englyst (1989)

| | | | | | | | |
|---|---|---|---|---|---|---|---|
| Cereal | Arabinoxylan | β-glucan | Cellulose | Mannose | Galactose | Uronic acid | Total |

Wheat^{A}

| | | | | | | | |
|---|---|---|---|---|---|---|---|
| Soluble | 1.8 | 0.4 | — | t | 0.2 | t | 2.4 |
| Insoluble | 6.3 | 0.4 | 2.0 | t | 0.1 | 0.2 | 9.0 |

Barley^{A}

| | | | | | | | |
|---|---|---|---|---|---|---|---|
| Soluble | 0.8 | 3.6 | — | t | 0.1 | t | 4.5 |
| insoluble | 7.1 | 0.7 | 3.9 | 0.2 | 0.1 | 0.2 | 12.2 |

Rye^{A}

| | | | | | | | |
|---|---|---|---|---|---|---|---|
| Soluble | 3.4 | 0.9 | — | 0.1 | 0.1 | 0.1 | 4.6 |
| Insoluble | 5.5 | 1.1 | 1.5 | 0.2 | 0.2 | 0.1 | 8.6 |

Oats^{A}

| | | | | | | | |
|---|---|---|---|---|---|---|---|
| Soluble | 0.8 | 2.8 | — | t | 0.1 | 0.1 | 3.8 |
| Insoluble | 14.7 | — | 10.1 | 0.2 | 0.1 | 1 | 24.5 |

Triticale^{B}

| | | | | | | | |
|---|---|---|---|---|---|---|---|
| Soluble | 1.3 | 0.2 | — | 0.02 | 0.1 | 0.1 | 1.7 |
| insoluble | 9.5 | 1.5 | 2.5 | 0.6 | 0.4 | 0.1 | 14.6 |

Sorghum^{B}

| | | | | | | | |
|---|---|---|---|---|---|---|---|
| Soluble | 0.1 | 0.1 | — | t | t | 1 | 0.2 |
| Insoluble | 2.0 | 0.1 | 2.2 | 0.1 | 0.15 | t | 4.6 |

Corn^{B}

| | | | | | | | |
|---|---|---|---|---|---|---|---|
| Soluble | 0.1 | t | — | t | t | t | 0.1 |
| insoluble | 5.1 | — | 2.0 | 0.2 | 0.6 | t | 8.0 |

Rice (pealed)^{B}

| | | | | | | | |
|---|---|---|---|---|---|---|---|
| Soluble | t | 0.1 | — | t | 0.1 | 0.1 | 0.3 |
| Insoluble | 0.2 | — | 0.3 | t | t | t | 0.5 |

Wheat pollard^{A}

| | | | | | | | |
|---|---|---|---|---|---|---|---|
| Soluble | 1.1 | 0.4 | — | t | 0.1 | 0.1 | 1.7 |
| insoluble | 20.8 | — | 10.7 | 0.4 | 0.7 | 1.0 | 33.6 |

Wheat bran^{B}

| | | | | | | | |
|---|---|---|---|---|---|---|---|
| Soluble | 2.6 | 0.2 | — | t | 0.1 | 0.3 | 3.2 |
| insoluble | 26.0 | — | 10.8 | 0.1 | 0.6 | 0.9 | 38.4 |

Rice bran (defatted)^{B}

| | | | | | | | |
|---|---|---|---|---|---|---|---|
| Soluble | 0.2 | t | — | t | 0.2 | t | 0.5 |
| Insoluble | 8.3 | — | 11.2 | 0.4 | 1.0 | 0.4 | 21.3 |

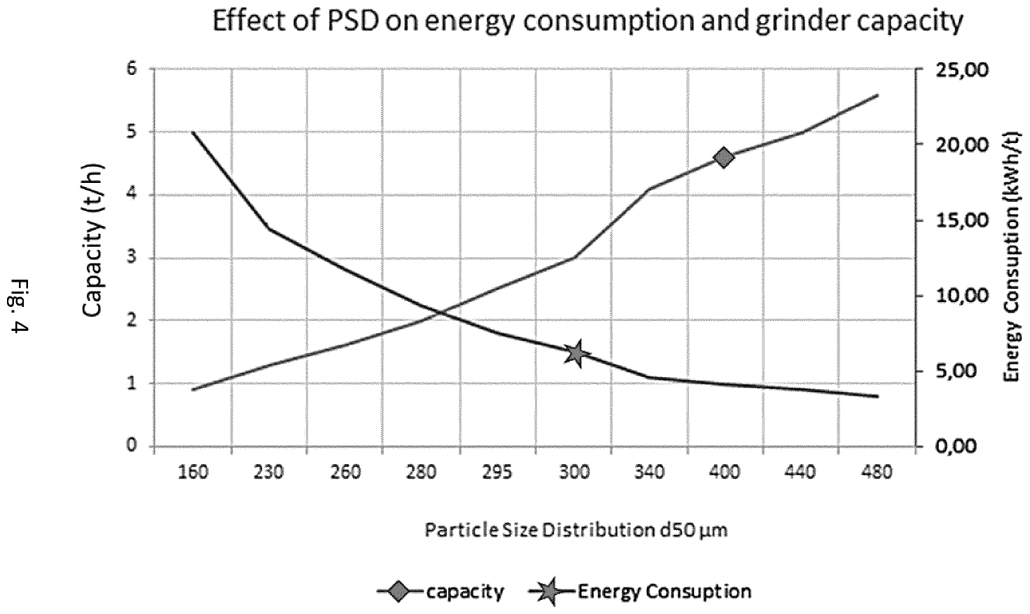

FIG. 4 shows the relationship between particle size (PSD, determined as d50 [μm] with respective sieves, as described elsewhere herein) and energy consumption (kWh/t) in the milling process, as obtained in a vertical Hammer mill with a 22 KW electric motor. It can be seen that with particle sizes of smaller than 230 μm, the energy consumption increases drastically. FIG. 4 shows also that with smaller particle size, also the hourly capacity of the mill is reduced. The raw data are as follows:

| | Sieve mesh | Energy | Capacity |
|---|---|---|---|
| d50 | size mm | Consumption kWh/t | ton/h |
| 160 | 0.4 | 20.78 | 0.9 |
| 230 | 0.6 | 14.38 | 1.3 |
| 260 | 0.8 | 11.69 | 1.6 |
| 280 | 1 | 9.35 | 2 |
| 295 | 1.25 | 7.48 | 2.5 |
| 300 | 1.5 | 6.23 | 3 |
| 340 | 2 | 4.56 | 4.1 |
| 400 | 2.5 | 4.07 | 4.6 |
| 440 | 3 | 3.74 | 5 |
| 480 | 4 | 3.34 | 5.6 |

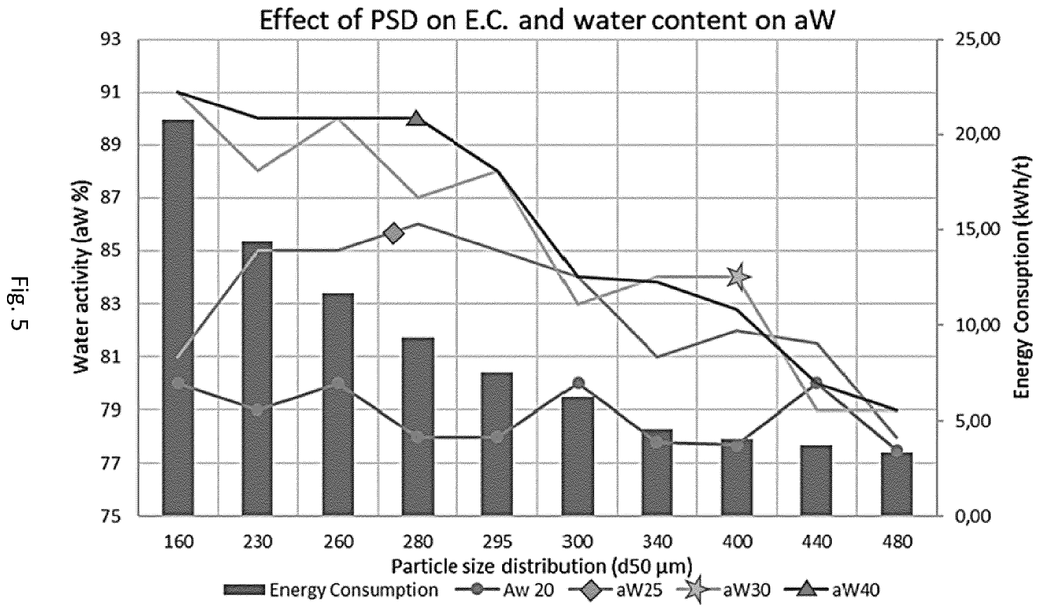

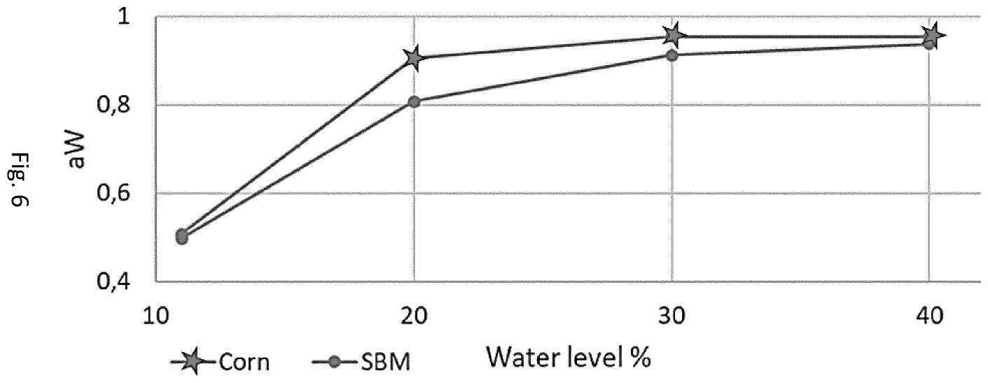

FIG. 5 shows the results of FIG. 4 (bar graphs), plus also the obtained water activity with different water contents. aW20 is the resulting water activity at a total water content of 20% w/w, aW50 is the resulting water activity at a total water content of 50%, and so forth. aW has been determined with a AWTherm lab analyzer (Rotronic AG, CH). It can be seen that at a total water content of 20% w/w, the water activity is quite independet from the milling grade, oscillating around 0.8.

FIG. 6 shows the relationship between total water content (% w/w) and water activity in corn meal and soy bean meal (SBM). Particle size was determined by a sieve having 1 mm screen size (D90<600 μm).

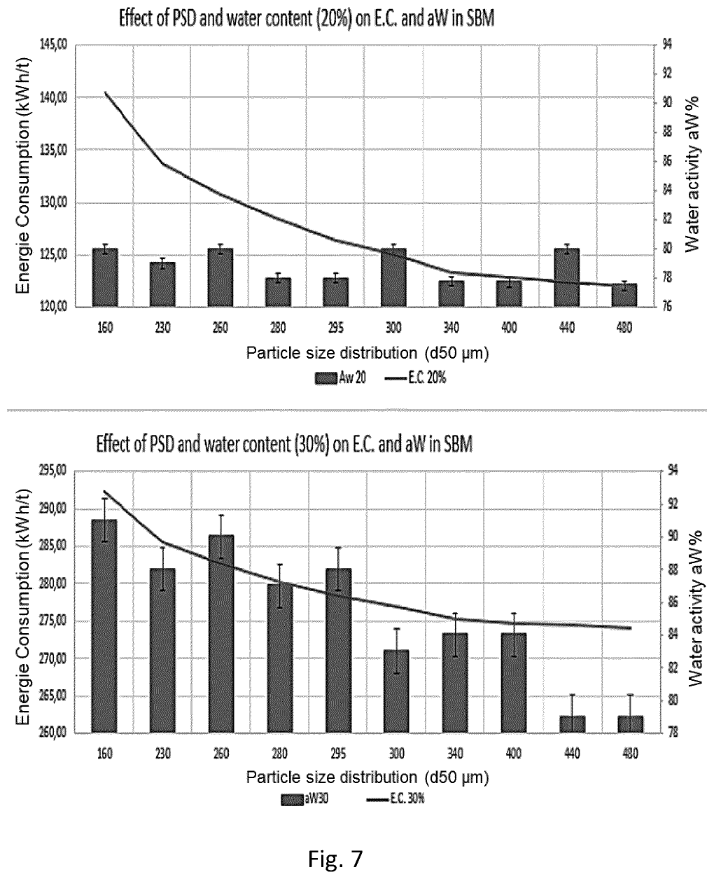

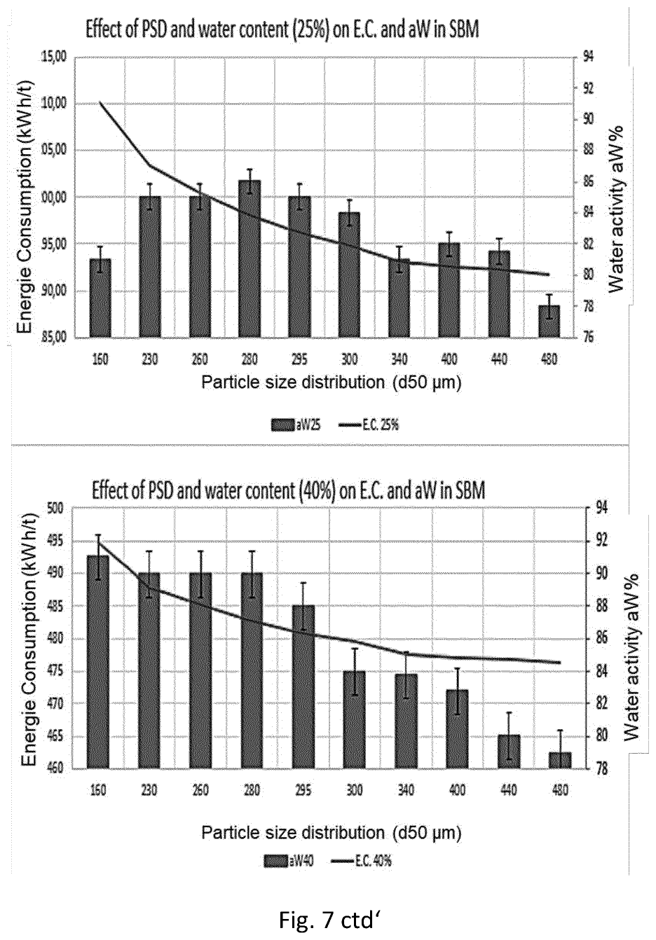

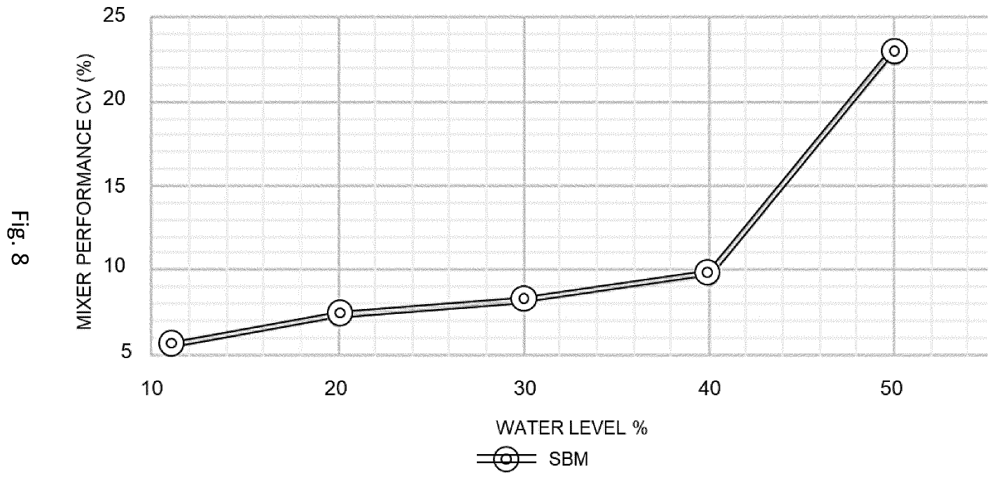

FIG. 7 shows the relationship between total energy costs (for milling and drying) in soy bean meal (SBM). It is clearly visible that a total water content of 30% w/W or higher escalates the energy costs, mainly because of the increased energy demand for drying. Drying has been performed in a convective dryer.

Product Final moisture level was 10%/w, with a capacity of 15 t/h. The energy consumption was calculated per ton of dried product, as shown in the table below

| Inlet dryer moisture level % | E.Consumpt. kWh/t |
|---|---|
| 20 | 113 |
| 25 | 180 |
| 30 | 257 |
| 40 | 450 |

FIG. 8 shows that, for obtaining a homogeneous mixing result prior to the fermentation, a moisture content in the meal is decisive. In the experiments, underlying FIG. 8, a meal comprising soybean and corn ground on a hammer mill with 1 mm screen size was used. Water was added to achieve a total water content of 10, 20, 30, 40 and 50% w/w. After mixing for 5 minutes in a 1000 l Single shaft paddle mixer with chopper knifes, an homogeneity test was done using the Chloride Titrator method with an NaCl marker added in concentration of 0.3% of the dry meal. The results are presented as the coefficient of variation (CV), with a CV of <10 representing an excellent mixing result/high homogeneity, and a CV or >20 representing a poor mixing result/low homogeneity. CV relates the standard deviation to the mean in the form of a percentage. Therefore, the CV is an effective tool for describing the variability present in the sample population.

The methodology is described in, inter alia, Fahrenholz and Stark, 2014, Herrman and Behnke, 1994. Traylor et al. 1994, Wicker and Poole, 1991 and Wilcox and Unruh, 1986, the contents of which are incorporated herein by reference for enablement purposes. The results show that a conventional mixer cannot handle meals with a total water content of higher than about 8% w/w. For meals comprising a water content of about 20% or higher, a custom made mixer was used that combines a single or twin shaft paddle mixer and a lump breaker, the latter comprising tulip knifes or high speed choppers.

FIG. 9 shows a mixer that can be used in the process according to the present invention due to its capability to obtain better homogeneity results in meal-water mixtures having a water content of >10% w/w., than a conventional shaft paddle mixer. The mixer of FIG. 9 is disclosed in EP publication EP3573744.

The mixer comprises a mixing chamber comprising a de-agglomerator (10) with a de-agglomeration shaft (11) with de-agglomeration means (12a, 12b, . . . ), a mixer (20) with a mixer shaft (21) with two or more mixing paddles (22a, 22b, . . . 23a, 23b, . . . , 24a, 24b, . . . ), arranged for mixing and impelling particles and powders in an upstream direction (u) towards the de-agglomerator (20).

The de-agglomeration shaft (11) is arranged above, and in parallel with said mixer shaft (21). The mixing chamber (1) further comprises a first portion (la) of said mixing chamber (1) having an inner profile adjacent and curved about an upper part of said de-agglomerator (10) and arranged to guide particles and powders impelled by said two or more mixing paddles (22a, 22b, . . . 23a, 23b, . . . , 24a, 24b, . . . ) over said de-agglomeration shaft (11). The mixer further comprises one or more spray means (30) arranged adjacent, above, and at a downstream particle flow side of said de-agglomerator (10), for providing a liquid spray (31) into a downstream flow from said mixing chamber (1).

### REFERENCES

Ramos M., Carabanio R., Boisen S., 1992. An in vitro method for estimating digestibility in rabbits. Journal of Applied Rabbit Research, 15, 938-946.
Boisen, S. & Fernandez, J. A. (1991 a). In vitro digestibility of energy and amino acids in pig feeds. In Digestive Physiology in Pigs, pp, 231-236 [M. W. A. Verstegen, J. Huisman and L. A. den Hartzog, editors]. Wageningen: Puduc.
Boisen S. & Eggum B. O (1991). Critical evaluation of in vitro methods for estimating digestibility in simple stomach animals. Nutrition Research Reviews (1991), 4, 141-162. National Institute of Animal Science, Foulum, DK-8830 Tjele, Denmark
Graham H, Aman P (2014) Carbohydrate chemistry, analysis and nutrition. In Proceedings of poultry feed quality conference. (Ed. T R Walker) Kuala Lumpur, Malaysia, 21-22 Aug. 2014. (Asian Agribusiness: Singapore)
Englyst H (1989) Classification and measurement of plant polysaccharides. Animal Feed Science and Technology 23, 27-42
American Society of Agricultural and Biological Engineers. 2008 R2012. Method of Determining and Expressing Fineness of Feed Materials by Sieving. In A. S. Engineers, American Society of Agricultural and Biological Engineers: St. Joseph, Mich.
Pfost, H. B. 1976. Grinding and Rolling. Feed Manufacturing Technology II. pp. 71-85. American Feed Manufacturers Association: Arlington, Va.
Stark, C. R. and Chewning, C. G. 2012. The effect of sieve agitators and dispersing agent on the Fahrenholz, A. and C. R. Stark. 2014. Mixing feeds and mixer test procedures for batch mixers. Feed Additive Compendium. Pages 105-108. Ed. T. Lundeen, Minnetonka, M N: Miller Publishing Co.
Herrman, T. and K. Behnke. 1994. Testing mixer performance. MF1172. Kansas State University Agricultural Experiment Station and Cooperative Extension Service Bulletin, Manhattan, Kans.: Kansas State University
Traylor, S. L., J. D. Hancock, K. C. Behnke, C. R. Stark and R. H. Hines. 1994. Mix time affects diet uniformity and growth performance of nursery and finishing pigs. KSU Swine Day Report, Pages 171-175. Kansas State University Agricultural Experiment Station and Cooperative Extension Service, Manhattan, Kans.: Kansas State University
Wicker, D. L. and D. R. Poole. 1991. How is your mixer performing? Feed Management (42):40.
Wilcox, R. and D. Unruh. 1986. Feed manufacturing problems-feed mixing times and feed mixers. MF-829, Kansas State University Agricultural Experiment Station and Cooperative Extension Service, Manhattan, Kans.: Kansas State University

What is claimed is:

1. A method of treating a raw feed material, the method comprising a grinding step, an enzymatic treatment step, and a drying step, wherein
a) the raw feed material is ground to a obtain a meal in the grinding step,
b) water is added and mixed into the meal to obtain a mixture, which is then subjected to an enzymatic treatment step with an enzyme preparation, to obtain an enzymatically treated mixture, and
c) the enzymatically treated mixture is dried in the drying step, and
wherein further
in step a), the grinding process is adjusted in such way as to deliver a meal that has a particle size, measured as d50, between ≥100 μm and ≤1000 μm
in step b), water is added to achieve a total water content of between ≥15% w/w and ≤40% w/w

2. The method according to claim 1, wherein, in step b) water is added to the meal to obtain a resulting water activity of ≥0.8.

3. The method according to claim 1, which method further comprises at least one step selected from the group consisting of:
at least one analysis step for determining key parameters of the raw feed material or an intermediate material, and/or
a hydrothermal treatment step to degrade fibres comprised in the raw feed material or an intermediate material.

4. The method according to any of the aforementioned claims, wherein the drying step serves to reduce the total water content of the feed material thus treated to ≤8% w/w.

5. The method according to any of the aforementioned claims, wherein the grinding step is performed with a hammer mill or a ball mill.

6. The method according to any one of the aforementioned claims, wherein the enzymatic treatment step is performed in one or more batch reactors.

7. The method according to claim 6, wherein multiple batch reactors are operated in a time-displaced manner.

8. The method according to any of the aforementioned claims, wherein the drying step serves to denaturate the enzymes added to the feed material.

9. The method according to any of the aforementioned claims, wherein the analysis step serves to determine at least one parameter selected from the group consisting of:
digestible protein content,
water activity,
total water content,
fibre content, and/or
content of antinutritional factors.

10. The method according to any of the aforementioned claims, wherein the one or more enzymes added to the feed material are selected from the group consisting of:
protease
phytase, and/or
carbohydrase (cellulase, hemicellulose, alpha-galactosidase)

11. The method according to any of the aforementioned claims, wherein the one or more enzymes added to the feed material are capable of degrading, digesting or hydrolyzing one or more anti nutritional factors (ANF).

12. The method according to any of the aforementioned claims, wherein one or more enzymes, and their dosage are selected according to the outcome of the analysis step.

13. The method according to any of the aforementioned claims, wherein the raw feed material is at least one selected from the group consisting of:
soy bean meal,
corn,
rapeseed,
sun flower meal,
barley,
wheat, and/or
DDGS (dried distillers grains with solubles).

14. The method according to any of the aforementioned claims, wherein for mixing water into the meal a mixer is used which combines a shaft paddle mixer and a lump breaker.

15. A feed material treated with a process according to any of the aforementioned claims.

16. A feedstuff comprising a feed material according to claim 15.

17. The feedstuff according to claim 16, which is provided as at least one of
pellets
powder, and/or
meal.

18. A system for carrying out the method according to any of the aforementioned claims, said system comprising
a mill to grind a raw feed material to obtain a meal,
a water supply to add water to the meal,
a mixer for mixing water into the meal,
an enzyme supply to add an enzyme preparation to the watered meal,
a fermenter for the enzymatic treatment of the thus treated watered meal,
and a dryer to dry the enzymatically treated meal.

19. The system according to claim 18, which system further comprises at least one device selected from the group consisting of:
an analysis unit for determining key parameters of the feed material, and/or
a hydrothermal treatment unit capable to degrade fibres comprised in the feed material or the meal obtained therefrom.

20. A feedmill comprising a system according to any of claims 18-19.
